(19) United States
(12) Patent Application Publication
(10) Pub. No.: US 2015/0213506 A1
(43) Pub. Date: Jul. 30, 2015

(54) METHODS AND SYSTEMS FOR IMPROVED ANALYSIS OF MASS COMMUNICATION CAMPAIGNS

(71) Applicant: DIGITAL WAVEFRONT, LLC, Burlington, MA (US)

(72) Inventors: Nirmal PARIKH, Burlington, MA (US); Nimisha ASTHAGIRI, Burlington, MA (US)

(21) Appl. No.: 14/607,650

(22) Filed: Jan. 28, 2015

Related U.S. Application Data
(60) Provisional application No. 61/932,389, filed on Jan. 28, 2014.

(51) Int. Cl. G06Q 30/02; G06Q 10/10

(52) U.S. Cl. CPC G06Q 30/0269; G06Q 10/107

(57) ABSTRACT

Systems, methods, and devices for providing improved data analysis of mass communication campaigns, such as e-mail campaigns. Various embodiments include receiving interaction data for multiple contact points over one or more mass communication campaigns, associating the interaction data for multiple contact points with each of a plurality of recipients of the one or more mass communication campaigns, for each recipient, generating at least one parameter based on the interaction data associated with the recipient over multiple contact points, and providing the at least one parameter to an originator of the mass communication campaign.

### RELATED APPLICATION

This application claims the benefit of priority to U.S. Provisional Application No. 61/932,389, filed Jan. 28, 2014, the entire contents of which are incorporated herein by reference.

### FIELD OF THE INVENTION

The present invention relates generally to systems and methods for providing data analysis of mass communication campaigns, such as mass electronic (e.g., e-mail) marketing campaigns.

### BACKGROUND

Email Service Providers (or ESPs for short) are companies that specialize in offering a platform to help create and send emails. Users create an account and get access to tools that they can use to create and send a series of on-demand or scheduled email campaigns. Examples of ESPs include Constant Contact, MailChimp, Campaign Monitor, Stream Send, iContact, ExactTarget etc.

A Marketing Automation Platform is a software platform that helps automate repetitive tasks related to sales and marketing using pre-defined workflows. Such tasks may include, but are not limited to, the designing and sending of emails based on the user profile and behavior-based triggers. These platforms offer tools to help users create and send a series of on-demand or automated emails. Examples include Marketo, Hubspot, Silverpop, etc.

Henceforth Email Service Providers and Marketing Automation Platforms will collectively be referenced as Mass Communication Providers (or MCPs).

A mass communication campaign, such as an email campaign, typically includes one or more targeted messages that are delivered to a plurality of recipients such as via an MCP. MCPs typically maintain rudimentary statistics relating to the recipient/customer interaction with the messages. For example, in the case of an e-mail campaign, these statistics may include:

Sents: A count of the number of people who the email was sent to. In a perfect world i.e. assuming no suppressions, this number would equal the number of emails that were delivered.

Opens: A count of the number of recipients who received the email and opted in to view or open it.

Clicks: A count of the number of recipients who received the email and clicked on at least 1 link within the email. This accurately measures and represents user engagement because an explicit action is performed.

Bounces (hard and soft): There are 2 types of bounces. Hard bounces represent a count of the number of recipients whose email addresses were either bad or undeliverable. This usually indicates a permanent error and re-delivery is not recommended. Soft bounces represent a temporary error that could be resolved over time and a re-attempted delivery could be successful. If the recipient's mail server is temporarily unavailable or a person's mailbox is full, it is considered a soft bounce.

Optouts: A count of the number of recipients who received the email and opted out of receiving future emails from the company. This generally indicates that the user is disinterested in the type of message (e.g. promotional, news, etc.) and/or the company.

There are a variety of different types of mass communication campaigns. Repeated/ongoing communications may include newsletters and trigger-based emails and are considered part of an overall lead nurture effort. They are typically sent to existing customers and/or prospects that are in various stages of the sales cycle. A one-time marketing communication message is an isolated one-time message typically sent to engage the prospective audience and get them interested in the company's product or service. Non-responders to such campaigns do not end up in any sales cycle and typically receive no further communication from the company.

### SUMMARY

The systems, methods, and devices of the various embodiments provide improved data analysis of mass communication campaigns, such as e-mail campaigns. In an embodiment, a method may include receiving interaction data for multiple contact points over one or more mass communication campaigns, associating the interaction data for multiple contact points with each of a plurality of recipients of the one or more mass communication campaigns, for each recipient, generating at least one parameter based on the interaction data associated with the recipient over multiple contact points, and providing the at least one parameter to an originator of the mass communication campaign.

In various embodiments, the at least one parameter may comprise a numerical value for a Personal Total User Score to quantify the interaction data over multiple contact points. In embodiments, a numerical Personal Interaction Score may be associated with each interaction, which may be weighted using a multiplier based on a numeric series, such as a geometric series, to create a Personal Weighted Interaction Score for each interaction. The Personal Total User Score may be a summation of all the Personal Weighted Interaction Scores for a given recipient.

Various embodiments may include presenting a historical depiction of recipient engagement over multiple contact points with a User Engagement Graph that summarizes the overall engagement pattern. Various embodiments may include presenting a numerical history of recipient engagement over multiple contact points with a User Engagement Vector. Various embodiments may include presenting all qualitative and quantitative historical recipient interaction data in a Scorecard Analysis dashboard.

In various embodiments, the mass communication campaign may comprise an e-mail campaign, the contact points may comprise e-mails sent to the plurality of recipients, and the user interaction data may comprise one or more of sends, opens, clicks, bounces and optouts. The interaction data may be received from various sources, including different MCPs

Further embodiments include receiving interaction data for a plurality of recipients of one or more mass communication campaigns, receiving attribute data for the plurality of recipients of the one or more mass communication campaigns, associating the attribute data with the interaction data for each of the plurality of recipients, and displaying interaction data for the one or more mass communication campaigns along one or more dimensions based on the attribute data. The attribute data may include demographic and/or psychographic information relating to the plurality of recipients of the mass communication campaign.

Various embodiments include systems, including computing devices, configured to perform operations of the embodiment methods disclosed herein. Various embodiments also include devices or systems including means for performing functions of the embodiment methods disclosed herein. Various embodiments also include non-transitory processor-readable storage media having stored thereon processor-executable instructions configured to cause a processor to perform operations of the embodiment methods disclosed herein.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of a system according to an embodiment.

FIG. 2 is a block diagram that schematically illustrates data collection from various providers according to one embodiment.

FIG. 3 is a flow diagram that schematically illustrates establishing a connector to an Mass Communication Provider (MCP).

FIG. 4 schematically illustrates the outputs from an embodiment system.

FIG. 5 schematically illustrates a scheme for weighing of interaction data according to an embodiment.

FIGS. 6A-C are examples of User Engagement Graphs according to an embodiment.

FIG. 7 is an example of a Scorecard Analysis dashboard according to an embodiment.

FIG. 8 is an example of a display of interaction data along an attribute-based dimension value according to an embodiment.

FIG. 9 is an example of a menu box for selecting attribute dimensions according to an embodiment.

FIG. 10 is an example of a display of interaction data along two attribute dimensions according to an embodiment.

FIG. 11 is a process flow diagram illustrating an embodiment method.

FIG. 12 is a process flow diagram illustrating another embodiment method.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “computing device” and “processing unit” are used interchangeably to refer to any one or all of desktop computers, server computers, workstation computers, personal data assistants (PDA's), laptop computers, tablet computers, smart phones, smart books, palm-top computers, gaming controllers, and similar electronic devices which include a programmable processor and memory and circuitry for sending and receiving data over a network.

As used herein the term “mass communication campaign” refers to at least one user-perceptible message (e.g., e-mail message, SMS message, targeted advertisement, social media message, etc.) that is sent by or under the direction or control of a first entity (i.e., an originator) to a plurality of pre-determined recipients (which may be interchangeably referred to as “end-users” or “customers”). Within a mass communication campaign, each instance of a message being sent to a particular end-user/recipient may be referred to as a “contact point.” A mass communication campaign may be generated and/or sent on behalf of the originating entity by a third-party service provider, such as a Mass Communication Provider (MCP).

Most originators of mass communication campaigns are currently focused on summary results provided by MCPs outlining emails sent, opened, clicked, bounced, optouts, etc. Summary reports may benefit from additional insights such as the frequency, recency and context of user interactions. For example, conventional summary reports may answer the “how many” part in the email response e.g. “How many users clicked on the email?”, but they fail to reveal, if it's the same, overlapping, or distinct set of users when compared with a previous email.

Such insights may be far more important to the decision-making process. For example, insights that can help the campaign originator identify engaged users and users who are at risk of opting out may greatly aid in adjusting the originator's messaging strategy.

There is a lack of an easily accessible software, tool or platform that offers these insights, presents them using a familiar interface and delivers them in real time. Various embodiments may provide such meaningful insights and decision-making power to the originator of a mass communication campaign.

There is also no existing tool that captures data across multiple MCPs and presents the data under one universal interface making it easier to deliver insights. This is especially challenging for campaign originators who manage campaigns across multiple MCPs. Such entities may need to rely on “isolated” dashboards offered by the respective MCPs to gain access to email campaign results. This problem is compounded as the number of MCPs increases.

Various embodiments include systems and methods that may capture, store, analyze and present information across multiple MCPs under one interface, which may be easily accessible via a web-based and/or mobile portal.

Most campaign originators are focused on increasing the absolute numbers i.e. sends, opens and clicks. But, not every email gets opened and not every opened email generates a click. In fact, when the average person receives 100+ emails per day, expecting someone to interact (open) or engage (click) with an email is unrealistic. Furthermore, summary results from a single mass communication may miss out on the overall picture. It may be akin to staring at one pixel of an image and not being able to know what the whole image is about. There is currently no scoring model to measure end-users' interactions and engagements over time.

What is currently lacking is a tool to analyze campaigns based on recipient attributes (demographic, psychographic, etc.) and/or historical behavior (opens, clicks, etc.). Various embodiments are directed to systems and methods having the ability to measure interactivity (opens), engagement (clicks) and other events, such as “no response” or “opt-out”, over time and assign each end-user a quantitative score.

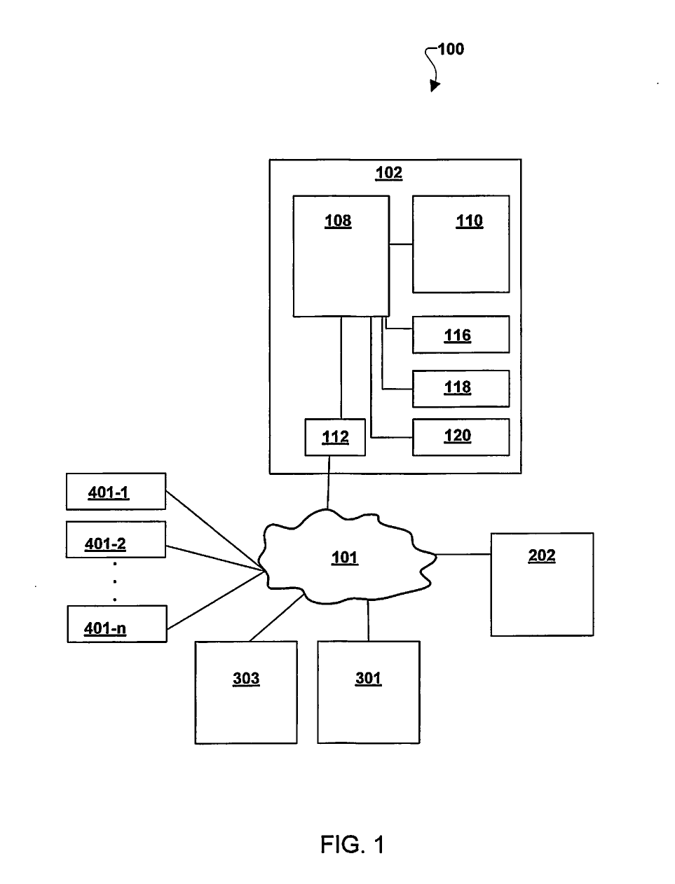

FIG. 1 schematically illustrates a system 100 according to one embodiment. The system 100 includes a computing device 102 (e.g., a server device) which may be configured to implement a mass communication campaign data analysis service. In one embodiment, the computing device 102 may host a web-based software-as-a-service (SaaS) application that provides a platform for an originator of a mass communication campaign to collect, store, analyze and visualize data relating to any number of mass communication messages and/or campaigns from any number of MCPs. The application may also utilize the collected data to generate novel metrics, such as quantitative and/or graphical metrics on a per-recipient basis and/or attribute data, regarding user-response to mass communication campaigns that may provide more useful insights than is available in a conventional report.

The computing device 102 may include a processor 108 coupled to internal memory 110. The processor 108 may be any programmable microprocessor, microcomputer or multiple processor chip or chips that can be configured by software instructions (applications) to perform a variety of functions, including the functions of the various embodiments described herein. Typically, software applications may be stored in the internal memory 110 before they are accessed and loaded into the processor 108.

The computing device 102 may also include a communication module 112 that enables the device 102 to transmit and receive data and signals to and from one or more external entities, such as external devices 202, 301, 303 and/or 401. The communication between the computing device 102 and external devices 202, 301, 303, 401 may be via a network 101, which may be a local area network (LAN) or a wide area network, such as the Internet. The computing device 102 may communicate with one or more external device 202, 301, 302, 401 using a wired and/or wireless link.

Other components of the computing device 102 may include an input/output device 116, such as a CD-ROM drive, USB port, etc., a display 118, and a user input device 120, such as a keyboard, mouse, touch pad, etc. The computing device 102 may further include or access a data store (not shown) for storing of current and/or historical data relating to mass communication campaigns (e.g., in a relational database). Alternatively or in addition, data related to mass communication campaigns may be stored in the internal memory 110.

The system 100 also includes an originator computing device 202 which may be associated with an originator of a mass communication campaign. The originator computing device 202 may be, for example, a desktop computer, a laptop computer, a tablet computer, a mobile device, a server, etc., and may be configured to communicate with one or more external entities, such as devices 102, 301, 303, 401, via the network 101. In one embodiment, the originator computing device 202 may be responsible for generating/sending one or more mass communication messages to a plurality of pre-determined recipients/end users. For example, a mass communication message may be an electronic message (e.g., an e-mail) sent via the network 101 to a plurality of recipient devices 401-1, 401-2, . . . 401-n associated with each of the predetermined recipients/end users (e.g., to particular e-mail addresses). In some embodiments, the actual sending of the messages may be performed by a third party provider, depicted as third party provider devices 301, 303 in FIG. 1, under the ultimate control or direction of the user of the originator device 202. The third party provider(s) 301, 303 may be, for example, Mass Communication Providers (MCPs). The third party providers 301, 303 may collect raw data regarding end-user interaction/end-user engagement with each mass communication message (e.g., total number of messages sent, number of opens, number of clicks, number of bounces, opt-outs, etc.).

In one embodiment, the computing device 102 may provide a subscription service to the originator computing device 202. For example, the computing device 102 may provide a web portal/interface that may be displayed on the originator computing device 202 and may enable the user of the originator computing device 202 to set up a subscription/user account with a subscription service hosted on computing device 102. The user may establish one or more connectors (e.g., logical data flows) that enable the computing device 102 to receive the raw data regarding end-user interaction/engagement with one or more messages of a mass communication campaign, as described in further detail below. In embodiments, the raw data may be collected or retrieved from one or more third-party sources, such as third party providers 301, 303. In some embodiments, the user of the originator computing device 202 may additionally upload or otherwise authorize the transmission of attribute data (e.g., demographic and/or psychographic information) for a plurality of the pre-determined recipients of a mass communication campaign, and the attribute data may be combined with the data regarding end-user interaction/engagement with the mass communication campaign as described in further detail below.

Although for clarity, the various components of the computing device 102 are shown as part of a single device, it will be understood that the computing device 102 may comprise a plurality of separate devices that may be in communication and configured to exchange data. Furthermore, although various embodiments of the system 100 include a web-based subscription-based system, other configurations are also possible. For example, rather than the application software for collecting, storing, analyzing and visualizing data related to mass communication campaigns being hosted on the computing device 102, all or a portion of the application software may be located on and executed by the originator computing device 202. In some embodiments, the software may be downloaded and installed on the originator computing device 202 via the network 101 (e.g., as a downloadable “app”). In other embodiments, all or a portion of the application software for collecting, storing, analyzing and visualizing data related to mass communication campaigns may be located on and executed by a third-party provider system 301, 303, such as a Mass Communication Provider (MCP).

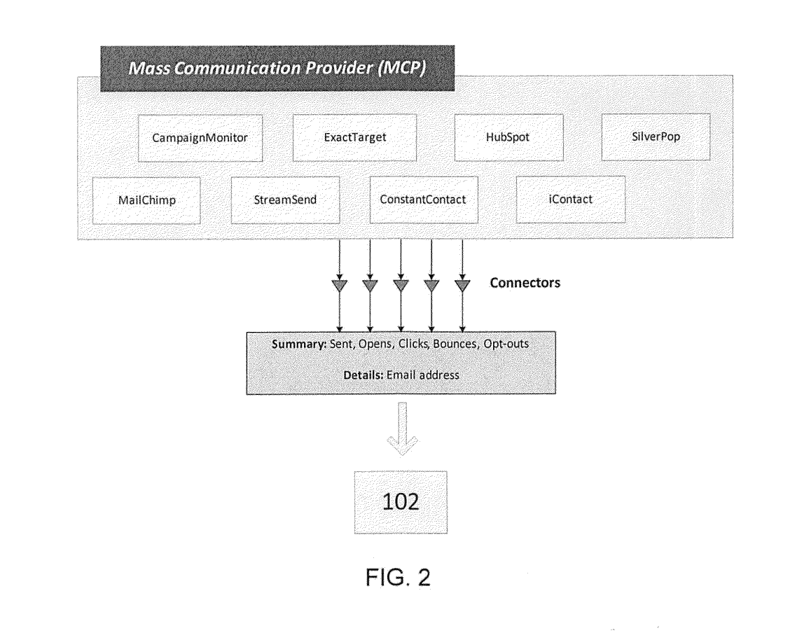

FIG. 2 is a block diagram that schematically illustrates how the application may collect data from various providers according to one embodiment. In one embodiment, the application executing on computing device 102 may establish one or more logical connections to providers, such as third party providers 301, 303 in FIG. 1. Each logical connection to a provider may be referred to as a Connector. The originator user may set up any number of Connectors (e.g., via an interface on the originator computing device 202). The Connectors may be to the same provider (e.g., for multiple campaigns handled by the same MCP) or to different MCPs. Each Connector may be associated with a single mass communication campaign, with a portion of a campaign (e.g., one or more contact points) or with multiple mass communication campaigns.

Each Connector may conceptually be considered as a “firehose” that brings back summary and detail information (e.g., raw data) regarding end-user interactions or engagements (such as e-mail opens and/or clicks) across one or more mass communication campaigns from a choice of providers as specified by the user of the originator device 201. The raw data may also include identification data (e.g., e-mail addresses, network locators (e.g., URLs), identifiers of end user devices 401-1, 401-2, . . . 401-n, etc.) that enables the data regarding each end-user's interactions/engagements to be associated with the respective end user. Various embodiments may support multiple Connectors offering an agnostic approach/method to connect with a service provider 301, 303 (e.g., a Mass Communication Provider (MCP)) of their choice. In embodiments, a Connector may be established with any third party provider 301, 303 that makes its data available (e.g., via an application programming interface (API)). By enabling a single entity to connect, capture, present and analyze the relevant data using a single universal platform/tool, the need for the originator user to use multiple provider-based interfaces may be eliminated.

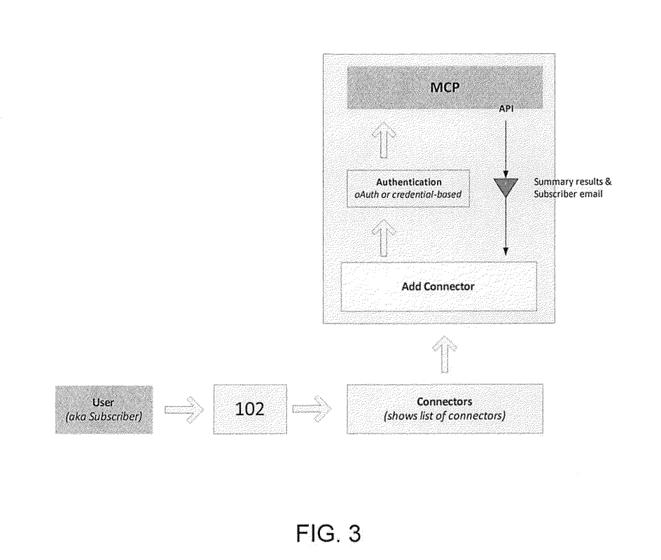

FIG. 3 schematically illustrates how an originator user (alternately referred to as a “Subscriber”) may set up a new Connector in one embodiment. Authentication may take place via OAuth or a credential-based system depending on the choice of provider 301, 303.

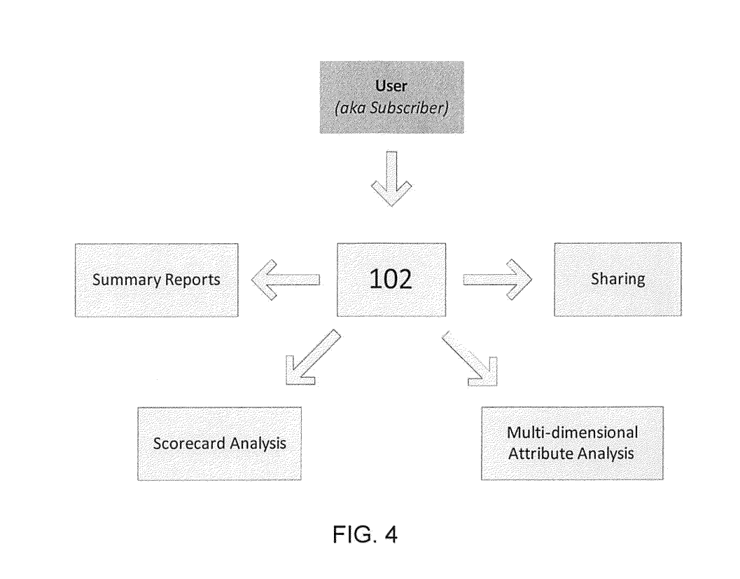

FIG. 4 schematically illustrates various outputs of the application software according to one embodiment. For example, an originator user/subscriber may log in to the subscription service and elect to view and/or receive Summary Reports of various mass communication campaigns (e.g., a conventional report of end-user interaction/engagement, including sent, opens, clicks, bounces, optouts, etc., for one or more campaigns), a Scorecard Analysis related to one or more mass communication campaigns (described in further detail below), and/or a Multi-dimensional Attribute Analysis related to one or more campaigns (described in further detail below). The subscriber may also choose to share the various outputs with another entity. Alternatively or in addition, one or more of these outputs (e.g., Summary Reports, Scorecard Analysis, Multi-dimensional Attribute Analysis) may be automatically sent to the originator device 201 (e.g., e-mailed to originator device 201) as the outputs are generated and/or on a periodic basis.

Scoring Model

Various embodiments may provide a holistic view of end-user/recipient interactions that take place over a period of time, a scenario consistently played out in email newsletters and other frequency-based email communication. Embodiments may generate a parameter (e.g., a collective (quantitative+qualitative) score) based on historical user interactions across multiple contact points with a recipient (e.g. across multiple communications and/or multiple campaigns). An end-user/recipient's combined behaviors over time may be captured and analyzed and an overall individual score, Personal Total User Score (PTU Score), may be generated for each end-user recipient. The PTU score may provide a more accurate view of each recipient's level of interest or engagement. In embodiments, the PTU score may assign more weight (importance) to recent interactions and less weight to interactions that have occurred in the distant past, lending further credibility to the scoring model.

The scoring model may identify behaviors and reveal patterns thereby empowering analysts and campaign originators to generate highly-personalized emails, increase conversions and deepen conversations. Thus, the originators of mass communication campaigns may more effectively make decisions around changing their content strategy to engage the “non-responders” or identify end-users that are disinterested, highly interested or engaged (which may be referred to as “fan club” members or “rising stars”) or represent opportunities waiting to be capitalized.

The following describes one exemplary implementation of a scoring model based on a recipient's interaction or engagement with one or more mass communication campaigns over time. It will be understood that other scoring models could also be utilized. Also, although the following example describes a scoring model based on a mass e-mail campaign, a similar scoring model may be utilized for other types of mass communication campaigns.

In one embodiment, a Personal Interaction Score (PI Score) is assigned to each end-user/recipient on a per contact point basis based on their interactions. For an e-mail campaign (that may have one or more contact point), the scores may be assigned as follows.

### Sent (S)=0

### Open (O)=1

### Click (C)=2

The table below shows an example recipient's (i.e., Mary's) PI Scores across 4 sample contact points (i.e., four separate e-mail messages sent to Mary's e-mail address).

Mary

| | Event | PI Score |
|---|---|---|
| Contact Point #1 | S | 0 |
| Contact Point #2 | O | 1 |
| Contact Point #3 | O | 1 |
| Contact Point #4 | O | 1 |

A Variation may be computed as the difference between the current and previous PI Scores. Therefore, by definition, Variation may only exist when comparing 2 or more discrete contact points within or across campaigns.

Variation=Current PI Score−Previous PI Score

Based on Mary's interactions her Variation may be computed as follows:

| | Mary | | |
|---|---|---|---|
| | Event | PI Score | Variation |
| Contact Point #1 | S | 0 | |
| Contact Point #2 | O | 1 | 1 |
| Contact Point #3 | O | 1 | 0 |
| Contact Point #4 | O | 1 | 0 |

A Personal Weighted Interaction Score (PWI Score) may also be computed. In one embodiment, the PWI Score is the weighted score of each end-user/recipient interaction per contact point. Recent interactions may be considered more valuable and would carry more weight than historical ones. The PWI Score may provide a more accurate picture of the end-user's history and their affinity towards the originator's campaigns. In one embodiment, weights may be assigned as a geometric series with the first term being ½ and each subsequent term being ½ of the previous term.

The most recent interaction may carry a weight of ½¹ (i.e. 0.5), the next most recent interaction may carry a weight of ½² (i.e. 0.25), the one after that may carry a weight of ½³ (i.e. 0.125) and so on. The last value in the series may also be added (as a weight) to the most recent interaction.

Represented mathematically, the weights may be the sequence shown below, where N is the number of discrete contact points.

$$\frac{1}{{2}^{1}} + \frac{1}{{2}^{N}} , \frac{1}{{2}^{2}} , \frac{1}{{2}^{3}} , \frac{1}{{2}^{4}} , \frac{1}{{2}^{5}} , \frac{1}{{2}^{6}} , … \frac{1}{{2}^{N}}$$

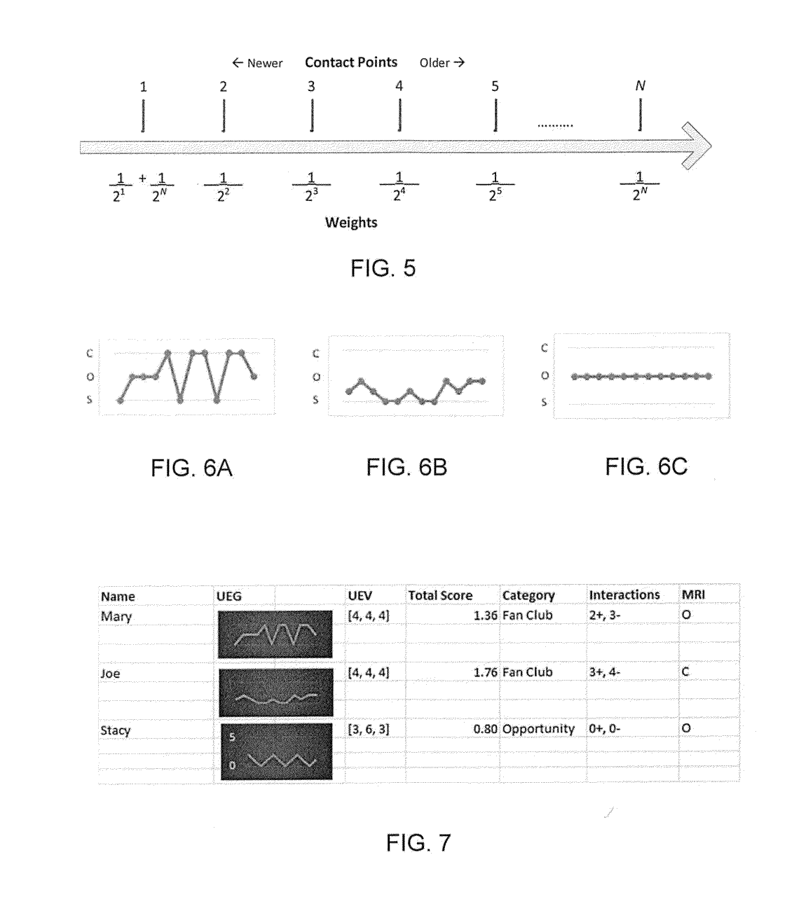

FIG. 5 graphically illustrates the weights assigned to N contact points according to one embodiment, with I being the most recent contact point carrying the most weight.

Thus, Mary's weighted scores (across 4 contact points) may look like the table shown below where Contact Point #4 is the most recent.

| | Mary | | | |
|---|---|---|---|---|
| | Event | PI Score | Variation | PWI Score |
| Contact Point #1 | S | 0 | | 0 |
| Contact Point #2 | O | 1 | 1 | 0.125 |
| Contact Point #3 | O | 1 | 0 | 0.25 |
| Contact Point #4 | O | 1 | 0 | 0.5625 |

A Personal Total User Score (PTU Score) may be calculated as the sum total of all PWI Scores. For example:

PTU Score=Sum of PWI Scores(Contact Point#1,Contact Point #2,Contact Point #3, . . . Contact Point #N)

Thus, Mary's PTU Score=0+0.125+0.25+0.5625=0.9375

Using the calculated PTU Score, each end-user/recipient may be classified into different categories based on their level of engagement/interest. The number of categories and the PTU score(s) for each category may be varied based on the needs of the particular originator of the campaign. In one exemplary embodiment, users may be classified in one of three distinct categories.

Fan Club: PTU Score of ≧1.0

These are end-users/recipients that show interaction and engagement by opening and clicking on email communications. They may not necessarily open or click each and every email, but demonstrate a positive affinity towards the email communications and/or the originator entity/company.

Opportunities: PTU Score of ≧0.5 and <1.

These end-users/recipients may present the biggest opportunity to a campaign originator. A PTU Score in this range may indicate that these recipients are on the cusp and could swing either way. The right content, the right amount of personalization, the right frequency, etc. could easily drive further interaction and engagement and may prevent them from a future optout.

Disinterested: PTU Score of <0.5

PTU Scores in this range may represent “at-risk” end-users/recipients. These are recipients who seem to show sporadic interaction and rarely engage with emails. Although this group also presents an opportunity at some level, it may demand a different strategy.

Given Mary's PTU Score of 0.9375, she represents an Opportunity for further engagement.

In an alternative embodiment, a user may be categorized based on both their PTU score and number of contact points (i.e., messages) that the user has received as a percentage of a total number of messages being analyzed (e.g., as part of one or more Mass Communication Campaigns). For example, a user may be categorized in the highest level of interest/engagement (e.g., Fan Club) when the user has a PTU score of ≧0.5 and the user has received at least half (≧50%) of the total contact points (i.e., messages) being analyzed. Another category (e.g., Rising Stars) may be those users who have a PTU score of ≧0.5 and the user has received less than half (<50%) of the total contact points (i.e., messages) being analyzed. Still another category (e.g., Opportunities) may be those users who have a PTU score of <0.5 and the user has received less than half (<50%) of the total contact points (i.e., messages) being analyzed. A final category (e.g., Disinterested) may be those users who have a PTU score of <0.5 and the user has received at least half (≦50%) of the total contact points (i.e., messages) being analyzed.

As discussed above, these categories are illustrative only, and may be variable as needed. In some embodiments, particular categories of user interest/engagement may be defined by originator user/subscriber (e.g., as a menu or configuration option of a web-based subscription service).

A User Engagement Graph (UEG) may be generated to visually plot an end-user/recipient's interactions across contact points. FIGS. 6A-C illustrate three example Engagement Graphs that plot user interactions (y-axis) across 12 contact points (x-axis).

A User Engagement Vector (UEV) may indicate the number of Sents, Opens and Clicks displayed as a vector adding up to the total number of contact points. For example:

[4, 0, 0]=4 clicks (out of a total of 4 contact points)
[3, 4, 0]=3 clicks, 4 opens (out of a total of 7 contact points)
[0, 2, 3]=0 clicks, 2 opens, 3 sent (out of a total of 5 contact points)

User Interactions (UI) may show a count of the positive (S→O, O→C), negative (C→O, O→S) and neutral interactions (S→S, O→O, C→C) that an end-user/recipient has had across multiple contact points.

Most Recent Interaction (MRI) indicates the most recent user interaction e.g. sent, open, click, etc. for a particular end-user/recipient.

All or a portion of the above-described generated parameters may be displayed in a unified dashboard and presented as a Scorecard Analysis. For example, the generated parameters may be transmitted in a suitable format to the originator computing device 201 (see FIG. 1) for rendering/display on the device 201. An embodiment of a Scorecard Analysis showing the results for three end-user/recipients is shown in FIG. 7.

Various embodiments may be less focused on the absolute and isolated interactions taking place within each contact point and more on learning about the user's history of interactions. The various embodiments described herein may provide a tool that offers meaningful insights to the originator.

Attribute Analysis

Embodiments may provide a multi-dimensional attribute analysis feature to further enhance insights based on source data that contains demographic (age, income, gender, education, household size, etc.) and/or psychographic (behavior, lifestyle, interests, etc.) information.

Overlaying this information with end-user/recipient interaction data gathered from mass communication campaigns (e.g., opens, clicks, optouts, bounces) may offer a very powerful view and lead to actionable insights. The multi-dimensional analysis may allow the campaign originator to effectively drill-down on specific segments of the data for further analysis.

For example, instead of just presenting 250 clicks, the tool may allow campaign originators to drill-down and visualize how many and which of those 250 clicks were males (gender breakdown) from the state of CA (state breakdown) who belonged to a high-income household (income distribution) and owned a Prius Hybrid (car make/model owned).

The following describes one exemplary implementation of an attribute analysis based on the recipient's interaction or engagement with one or more mass communication campaigns. It will be understood that other attribute analysis models could also be utilized. Also, although the following example describes attribute analysis based on interaction with a mass e-mail campaign, a similar attribute analysis may be utilized for other types of mass communication campaigns.

In one embodiment, the application software may receive end-user/recipient interaction data gathered from one or more mass communication campaigns (e.g. opens, clicks, optouts, bounces) in addition to source data file (e.g. a CSV file) containing demographic and/or psychographic data for all or a portion of the recipients of the one or more mass communication (e.g. email) campaigns. In one embodiment, the source data file may be uploaded to the host computing device 102 (e.g. server) of the subscription service from the originator device 202 (see FIG. 1). In other embodiments, the computing device 102 may receive the demographic/psychographic data from another source (e.g. a third-party source), as authorized by the campaign originator. The demographic/psychographic data may contain sufficient identifying information to enable the data to be associated with particular end-users/recipients (e.g., the data may be associated with particular e-mail addresses). After processing the file and parsing the data contained therein, each column header may be displayed as a dimension that the campaign originator/subscriber user may select from a drop-down menu.

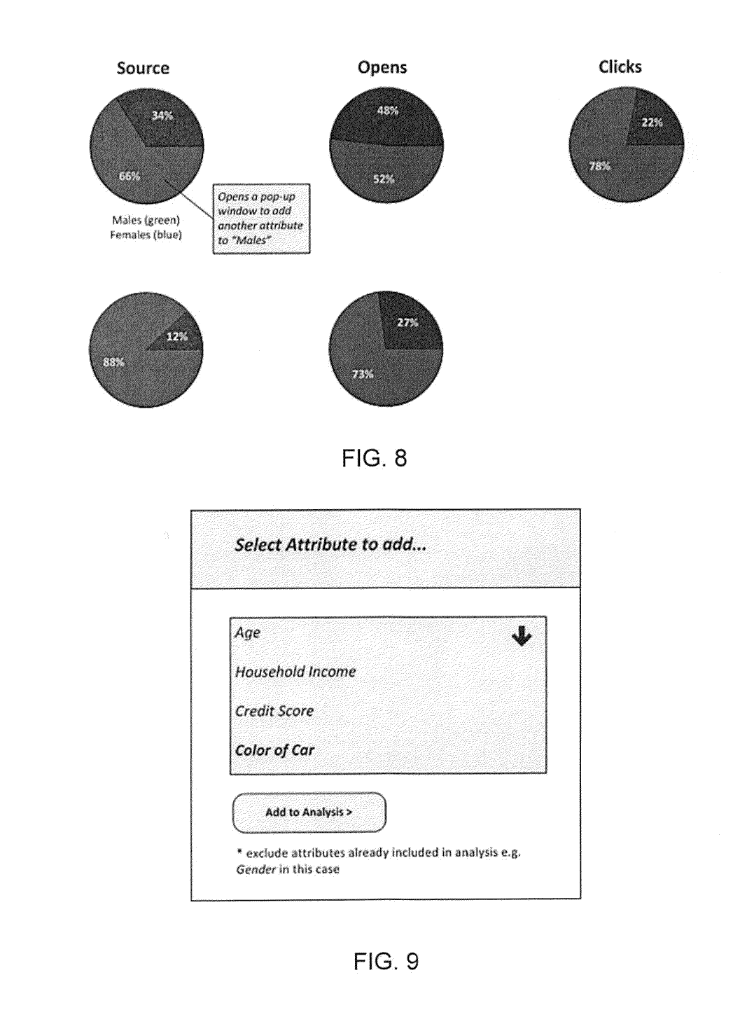

Once the subscriber selects a dimension (e.g. gender), the application may display the results across that dimension for each recipient interaction event (e.g. Opens, Clicks, Optouts and Bounces). In this case, each event may be split into the available dimension-values e.g. Males & Females. An example in the form of a series of pie-charts is illustrated in FIG. 8.

The subscriber may further refine this data by selecting one or more additional attributes. For example, by clicking on a particular slice, the subscriber may be presented with an option to add the new dimension, e.g. color of car. FIG. 9 illustrates an embodiment of a menu box that enables the subscriber to select an additional dimension.

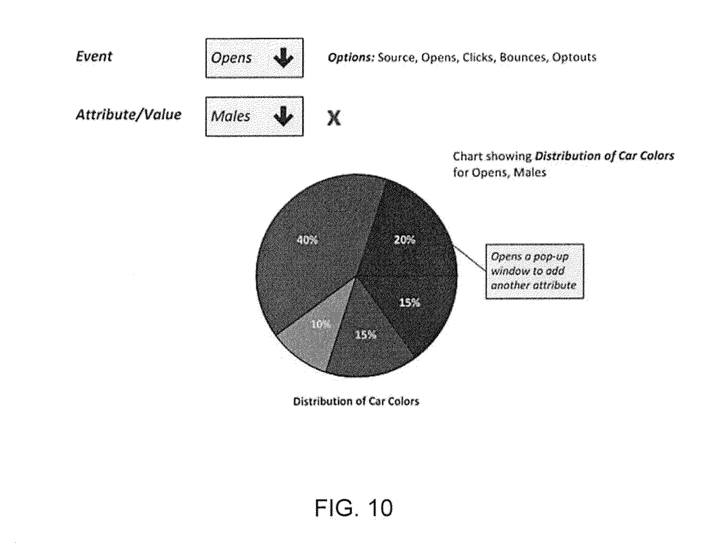

Once that dimension has been added, the system may further process the data and visualize the results by presenting a breakdown by different car colors, as shown in FIG. 10.

The attribute analysis may be used in conjunction with the historical campaign interaction scoring model described above. For example, instead of sorting and displaying by interaction event (e.g., open, click, etc.), the results may be sorted and displayed based on the historical data scoring model (e.g., by PWI Score, PTU Score, Category, or other similar parameters based on historical interaction/engagement data) in combination with the defined dimensions based on demographic/psychographic attribute data. For example, the system may provide an easily visualized breakdown of users in various categories (e.g. “fan club,” “rising star,” “opportunity,” “disinterested,” or similar categories) along one or more dimensions (e.g., gender, age, income range, lifestyle, etc.).

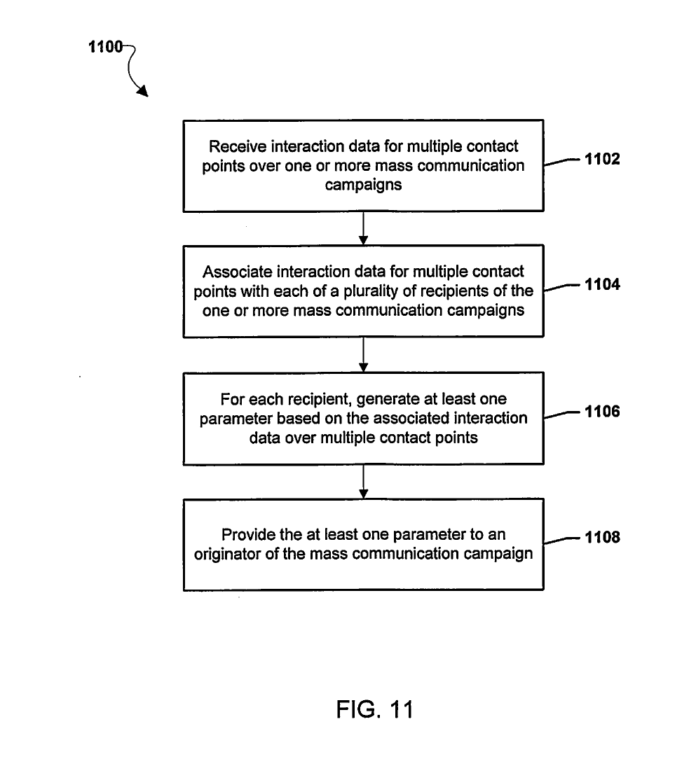

FIG. 11 illustrates an embodiment method 1100 for analyzing data regarding a mass communication campaign. In an embodiment, the operations of method 1100 may be performed by a processor of a computing device, such as computing device 102 in FIG. 1. In another embodiment, the operations of method 1100 may be performed by the processors of one or more device, which may be connected by a network. In block 1102, interaction data for multiple contact points over one or more mass communication campaigns is received. As described above, each contact point may comprise an instance of a message (e.g., an e-mail message) being sent to a particular end-user/recipient. The interaction data may comprise any data regarding a recipient's interaction with or response to a contact point. For example, for an e-mail campaign, the interaction data may comprise data relating to each of the e-mail messages (e.g., sends, opens, clicks, bounces, optouts, etc.). In addition to the above, the interaction data may comprise any data regarding a recipient's action(s) in response to a contact point, including, without limitation, data regarding whether the recipient opened/accessed the message, viewed or read the message, or took some further action in response to the message, such as sending a response to the message, clicking on a link within the message, visiting a particular website or calling a phone number identified in the message, or purchasing a product or service identified in the message. For example, the interaction data may comprise data from a call center (e.g., where the message invites the recipient to call a particular number), purchase or e-commerce data (e.g., where the message advertises a particular product or service), visits to a particular website, etc. The interaction data may be received electronically over a network (such as network 101 in FIG. 1), and may be received directly from the recipients of the mass communication campaign (e.g., devices 401-1, 401-2, . . . 401-n in FIG. 1) and/or from one or more third-parties (e.g., third party providers 301, 303 in FIG. 1).

In block 1104, interaction data for multiple contact points (e.g., messages) is associated with each of a plurality of recipients of the one or more mass communication campaigns. For example, in an e-mail campaign, each e-mail address may be associated with historical data regarding that recipient's interactions over multiple contact points (e.g., number of sends, opens, clicks, bounces, optouts, etc.). In block 1106, for each recipient, at least one parameter is generated based on the interaction data over multiple contact points associated with that recipient. For example, the parameter may comprise a numerical value (e.g., a Personal Total User Score) that quantifies the recipient's multiple interactions over a series of contact points. In other embodiments, the parameter may be a weighted score that weighs a particular interaction based on the recipient's history of interactions to multiple contact points. The parameter may comprise a graphical and/or vector depiction of historical user engagement/interaction over a multiple contact points. The parameter may be a category into which the recipient is assigned based on the interaction data over multiple contact points associated with that recipient. In block 1108, the at least one parameter may be provided to an originator of the mass communication campaign. For example, one or more generated parameters for each recipient may be displayed visually in a dashboard-style interface. In some embodiments, a subsequent contact point (e.g., message) may be sent to a recipient based on the parameter generated for that recipient.

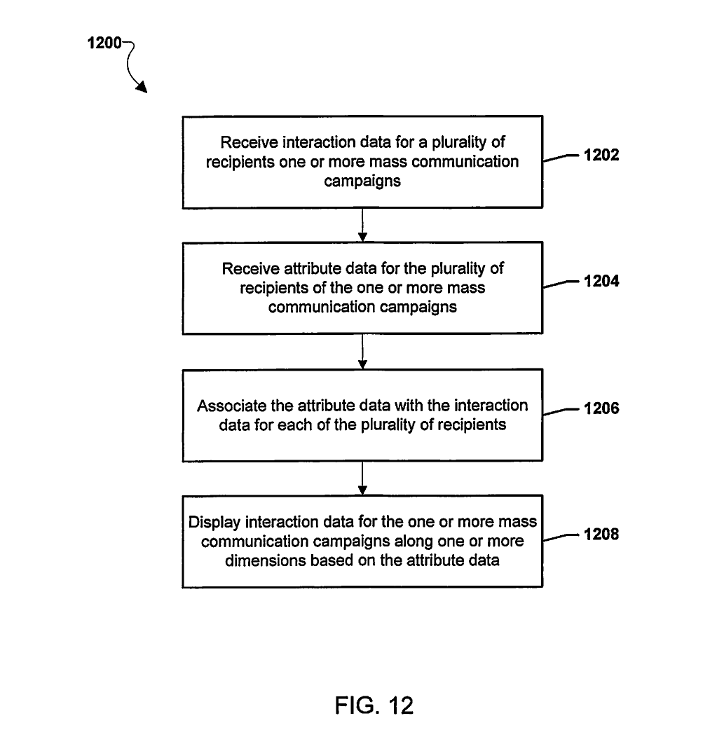

FIG. 12 illustrates an embodiment method 1200 for analyzing data regarding a mass communication campaign. In an embodiment, the operations of method 1200 may be performed by a processor of a computing device, such as computing device 102 in FIG. 1. In another embodiment, the operations of method 1200 may be performed by the processors of one or more device, which may be connected by a network. In block 1202, interaction data for a plurality of recipients of one or more mass communication campaigns is received. As described above, the interaction data may comprise interaction data for e-mail messages (e.g., sends, opens, clicks, bounces, optouts, etc.) or any data regarding a recipient's action in response to a similar communication. The interaction data may be received electronically over a network (such as network 101 in FIG. 1), and may be received directly from the recipients of the mass communication campaign (e.g., devices 401-1, 401-2, . . . 401-n in FIG. 1) and/or from one or more third-parties (e.g., third party providers 301, 303 in FIG. 1).

In block 1204, attribute data for the plurality of recipients of the one or more mass communication campaigns is received. The attribute data may comprise demographic and/or psychographic data regarding the recipients, as described above. The attribute data may be received electronically over a network (such as network 101 in FIG. 1), and may be received from the originator of the mass communication campaign (e.g., originator device 201 in FIG. 1) and/or from any other source. For example, the attribute data may be uploaded as a source data file that associates each of the recipients with attribute data.

In block 1206, the attribute data is associated with the interaction data for each of the plurality of recipients. In block 1208, the interaction data for one or more mass communication campaigns is displayed along one or more dimensions based on the attribute data. For example, data for various types of recipient interactions (e.g., opens, clicks, optouts, etc. in the case of e-mail campaigns) may be displayed along one or more demographic and/or psychographic-based dimensions (e.g., gender, age, income, etc.).

Various embodiments may provide methods and systems for improving mass communication campaigns, such as e-mail campaigns, conducted over an electronic communication network (e.g., the Internet), by capturing and analyzing the end user/recipients' combined behaviors over time to provide a more accurate view of each recipient's level of interest or engagement. The unique insights provided in accordance with the various embodiments may aid the originator of the mass communication to more precisely tailor further messages to the same end-user/recipients and/or to different end-users/recipients. The various embodiments may improve the functioning of computer devices and computer networks by reducing the resources and bandwidth required to perform highly-effective mass communication campaigns. The various embodiments may improve the functioning of computer devices and computer networks by capturing data regarding mass communication campaigns across multiple MCPs and presenting the data under one universal interface making it easier to deliver insights. Also, the various embodiments may improve the functioning of a computer device by enabling a graphical user interface to better visualize the effectiveness of mass communication campaigns, such as via a Scorecard Analysis and multi-dimensional attribute analysis for end-user/recipients, in a manner that previous computing devices could not.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of improving mass communication campaigns conducted over an electronic communication network, comprising:
receiving interaction data for multiple contact points over one or more mass communication campaigns;
associating the interaction data for multiple contact points with each of a plurality of recipients of the one or more mass communication campaigns;
for each recipient, generating at least one parameter based on the interaction data associated with the recipient over multiple contact points; and
providing the at least one parameter to an originator of the mass communication campaign.

2. The method claim 1, wherein generating the at least one parameter comprises computing a numerical value for a Personal Total User Score to quantify the interaction data over multiple contact points.

3. The method of claim 2, wherein a numerical Personal Interaction Score is associated with each user interaction.

4. The method of claim 3, wherein a numerical series is multiplied with the Personal Interaction Score to create a Personal Weighted Interaction Score, thereby giving more significance to more recent interactions.

5. The method of claim 4, wherein the Personal Total User Score is a summation of all the Personal Weighted Interaction Scores.

6. The method of claim 1, wherein providing the at least one parameter comprises pictorially presenting a historical depiction of recipient engagement over multiple contact points with a User Engagement Graph that summarizes the overall engagement pattern.

7. The method of claim 1, wherein providing the at least one parameter comprises presenting a numerical history of recipient engagement over multiple contact points with a User Engagement Vector.

8. The method of claim 1, wherein generating at least one parameter comprises computing recipient behavior variations by assigning positive and negative values to interaction changes and computing the summation of all positive variations and all negative variations.

9. The method of claim 1, wherein providing the at least one parameter comprises presenting all qualitative and quantitative historical recipient interaction data in a Scorecard Analysis dashboard.

10. The method of claim 1, further comprising cross-referencing attributional source data with the interaction data to create a multi-dimensional attribute analysis tool.

11. The method of claim 10, further comprising providing an ability to drill-down on attribute dimensions by choosing slices and selecting additional dimensions.

12. The method of claim 1, wherein the interaction data is received from a plurality of sources, wherein at least one source comprises a Mass Communication Provider.

13. The method of claim 1, wherein the mass communication campaign comprises an e-mail campaign, the contact points comprise e-mails sent to the plurality of recipients, and the user interaction data comprises one or more of sends, opens, clicks, bounces and optouts.

14. A method of improving mass communication campaigns conducted over an electronic communication network, comprising:
receiving interaction data for a plurality of recipients of one or more mass communication campaigns;
receiving attribute data for the plurality of recipients of the one or more mass communication campaigns;
associating the attribute data with the interaction data for each of the plurality of recipients; and
displaying interaction data for the one or more mass communication campaigns along one or more dimensions based on the attribute data.

15. The method of claim 14, wherein the attribute data comprises demographic and/or psychographic data for the plurality of recipients.

16. The method of claim 14, wherein the mass communication campaign comprises an e-mail campaign comprising one or more e-mail sent to the plurality of recipients, and the user interaction data comprises one or more of sends, opens, clicks, bounces and optouts.

17. The method of claim 14, further comprising displaying interaction data for the one or more mass communication campaigns along two or more dimensions based on the attribute data.

18. A computing device, comprising:
a memory; and
a processor coupled to the memory and configured with processor-executable instructions to perform the operations of claim 1.

19. A non-transitory computer readable storage medium having stored thereon processor-executable instructions configured to cause a processor of a computing device to perform the operations of claim 1.

20. A computing device, comprising:
a memory; and
a processor coupled to the memory and configured with processor-executable instructions to perform operations, comprising:
establishing a connection via a network with at least two different mass communication providers;
receiving interaction data for multiple contact points over one or more mass communication campaigns from the at least two different mass communication providers;
combining the received interaction data; and
providing the combined data to an originator of the mass communication campaign.
